(19) United States
(12) Patent Application Publication
(10) Pub. No.: US 2015/0134547 A1
(43) Pub. Date: May 14, 2015

(54) BELONGINGS VISUALIZATION AND RECORD SYSTEM

(71) Applicant: Artases OIKONOMIDIS, Moscow (RU)

(72) Inventor: Artases OIKONOMIDIS, Moscow (RU)

(21) Appl. No.: 14/076,197

(22) Filed: Nov. 9, 2013

(51) Int. Cl. G06F 17/30; G06Q 30/02

(52) U.S. Cl. CPC G06F 17/30265; G06Q 30/0278
USPC 705/306; 235/375

(57) ABSTRACT

A belongings visualization and records method and system is disclosed. The method comprises receiving a digital representation of a machine-readable, visual code captured with a portable device, the visual code being associated with an item; scanning the received visual code for an item identifier; generating an item image from the item identifier, the item image consisting of a three-dimensional computer image representing the item; placing the item image in a physical space image, the physical space image consisting of a three-dimensional computer image representing a physical space; associating digital files with the item image; associating the item image with a user profile; and displaying the item image and the physical space image to a user on a computer screen.

### TECHNICAL FIELD

The present invention relates broadly to computer graphics and database management. Specifically, the present invention relates to presenting visual representations of objects as they are placed by a user in a three dimensional image. More specifically, the objects are associated with files containing information about the object as well as index information for grouping the objects with other objects.

### BACKGROUND

Computer generated images have given users a virtual environment experience, where the user interacts with elements within a three-dimensional environment. First brought to the masses through games, virtual environments are visual in nature, and display a three-dimensional image to a user that may change as a user moves around in it or manipulates objects shown in the image. For environments that allow a user to create and manipulate representations of real world objects, the objects are typically provided in a library to a user or limited to drawing rules that control how a user generates the object's image. The realistic appearance of the virtual environment is a mark of quality among the graphics developer community, and an experience that causes a user to wonder if they are looking at video or computer graphics is considered the result of viewing a high-quality, virtual environment. But such rendering quality is computationally expensive, and it remains a complex task to introduce an endless number of new objects. Similarly, users typically don't possess the time, skills, patience, or even desire to draw an endless number of objects in the virtual space they experience.

Hand-held computing power is now widespread throughout the world. A typical cell phone has a video-capable screen and processing power for computer graphics and usually has a camera and microphone so it captures video and audio and still images. People compile large collections of photographs and video using these portable computing devices and share them on the internet. They also use browsers to access more digital content in the form of text, video and audio, still photographs and computer generated images. There exists a heartfelt need to somehow capture real world objects and present them to a user as representations in a virtual environment in a useful application.

### SUMMARY

The present invention solves the problems described above by providing an environment that presents representations of real-world objects to a user in a three-dimensional virtual space. Visual codes, such as bar codes are computer-readable codes that contain potentially thousands of characters that can be used to convey information related to an item. According to embodiments described herein, a user can scan a visual code associated with an object, either placed on the object itself or on a package that contains the item, or on an advertisement for the object, or other instance where the product's visual code appears, and use the captured visual code to obtain digital assets that are related to the object. For example, by scanning the visual code, the user submits the visual code to a browser that can handle the code in a variety of ways. The code can yield a search string, a universal resource locator indicating a manufacturer website, linking product information, images such as still photographs, audio and video descriptions, computer image representations related to the product, warranty information, purchase transaction details, product serial number, usage instructions, location of sale, product history information, and the like. A user can capture this code using a portable device, such as smart phone carried by the user into a store. In an embodiment, the code can be password protected, so that anyone who captures the code must provide a password to access the items associated with the code. In a browser embodiment, the user can also retrieve visual codes by downloading them from websites that sell, review, or somehow discuss or display the product and the visual code.

Scanned visual codes can be uploaded to a website that allows a user to create a three-dimensional, virtual environment in which the visual codes can be used to generate their related objects within the virtual space. Examples include a living room, a kitchen, a bedroom, a garage, a garden, a dining room, a warehouse, an office a store or shop, a bar, a restaurant, a club, or any place a user wishes to place objects related to the scanned code. Users can create virtual environments for practically any space where they spend time and use objects that are scanned and uploaded as codes. In this manner, all of a person's belongings can be inventoried, categorized and represented online, and stored with any information related to the product that can be reproduced in digital form. Placement of objects can be in any manner a user wishes; for example, a user may place furniture in a room, either from a stock library of images or by obtaining the visual code for the furniture, and place other objects inside it. In such an example, a user may select an entertainment center from one source, stereo equipment from a second source, and computer equipment from a third source. The sources themselves may be stores displaying such merchandise, online sources, or products already in the user's possession that bears a visual tag that the user may capture.

The virtual space created by the user can be representative of their real world environment, and display items in a user's possession where they are used by the person in their daily life, which would make the present invention a useful tool for home insurance purposes, and can be an organizational tool that allows a user to search for a misplaced or forgotten object by executing a search for the visual tag's information, or can be a way that a user stores information such as warranties, purchase receipts, user manuals, product updates, and the like, basically all of the paper documents that typically relate to an object in conventional environments.

The virtual space created by the user can be yet-to-exist environments that the user is creating to aid the design or remodel of a living space or work space; in a shopping application, for example where a couple planning a wedding creates wedding registries at various stores, the virtual space can be created by the user, populated with items appearing on a wedding registry, so that guests can enter the couple's online virtual home, and select items for purchase that appear in the home. By selecting an object, a purchaser can find online purchase opportunities, product information and pricing, and mark the item as sold so that duplicate purchases aren't made by other visitors to the environment. Or, regardless of registry, a customer can specify a discount desired by the customer on groups of objects, perhaps linked also by manufacturer or vendor or other criteria.

The virtual space created by the user can be created by sellers of products as well, for example a department store that sells kitchen appliances could place online a virtual kitchen where shoppers can populate the kitchen with appliances they select, a “dream kitchen” and register the configuration with the vendor. Using the user's selections, the vendor can contact the seller with buying incentives, new product recommendations, and the like, in an effort to attract purchases from the user. In an embodiment, a user can place in the environment an item not sold by the vendor, which is useful information to the vendor from a merchandising standpoint. In order to increase sales, the vendor may encourage this from users so that the vendor can make adjustments to product offerings and sell products that the user desires.

In an embodiment, the virtual space created can become a major feature of a user's profile on a social network or other collection of users who communicate to a significant degree by construction of a personal profile.

In embodiments, monitoring functions can be performed in accordance with the items associated with the visual codes. For example, updates to individual items such as computers, smart phones, and other consumer electronics can be downloaded from a server at the user's discretion, and applied to a target device by the user. Similarly, for products that require maintenance or service, or possibly safety bulletins or recalls, such as for automobiles, appliances, alerts for such services can be searched for based on the scanned visual code, and notifications can be generated and presented to the user. Many other features and advantages will be apparent to those skilled in the art upon reading the following description, when considered in conjunction with the accompanying drawings.

### BRIEF DESCRIPTION OF THE DRAWINGS

FIG. 1 illustrates in functional block diagram form a user device in communication with a server device.

FIG. 2 illustrates the block diagram of FIG. 1 with a browser application shown operating on the user device.

FIG. 3 illustrates in functional block diagram form modules operating on a server device.

FIG. 4 illustrates a user interface for operating functional modules of FIG. 3.

FIGS. 5-7 illustrate three-dimensional spaces in which a user may place object images.

FIG. 8 illustrates a sequence of acts executed in accordance with embodiments of the invention.

FIG. 9 illustrates a method for reminding a user to update or replace an object item based on technological capabilities according to one embodiment.

FIG. 10 illustrates a network of devices used in accordance with embodiments of the invention.

FIG. 11 illustrates in functional block diagram form components found in the user device and server device.

### DESCRIPTION

In the following description, for purposes of explanation and not limitation, specific details are set forth, such as particular preferred embodiments, procedures, techniques, etc. in order to provide a thorough understanding of the present invention. However, it will be apparent to one skilled in the art that the present invention may be practiced in other embodiments that depart from these specific details.

Technical features described herein can be used to construct various embodiments of a system for visualizing belongings and associated them with related documents, notifications, service updates, service appointments and the like.

Files, as referred to herein, generally are digital assets such as documents, emails, photographs, videos, audio files, and the like, which are capable of being stored digitally and reproduced on remote devices when disseminated across a computer network.

User devices, as referred to herein, generally are computing devices that communicate with a server across a computer network. User devices may be client devices such as any computing device capable of receiving and sending file sharing information over an electronic network. Such user devices may include personal computers, multiprocessor systems, micro-processor based or programmable consumer electronics. Examples include desktop computers, laptop computers, tabular computers, notebook computers, cell phones, smart phones, display pagers, handheld or other wearable devices and the like. User devices may be web-enabled client devices that can communicate over the web and include a browser application that is configured to receive and transmit web pages, web messages and other web information. The browser application may be configured to send, receive and display text, graphics, multimedia by means of a network protocol such as but not limited to Hypertext Transfer Protocol (HTTP) and/or wireless application protocol (WAP).

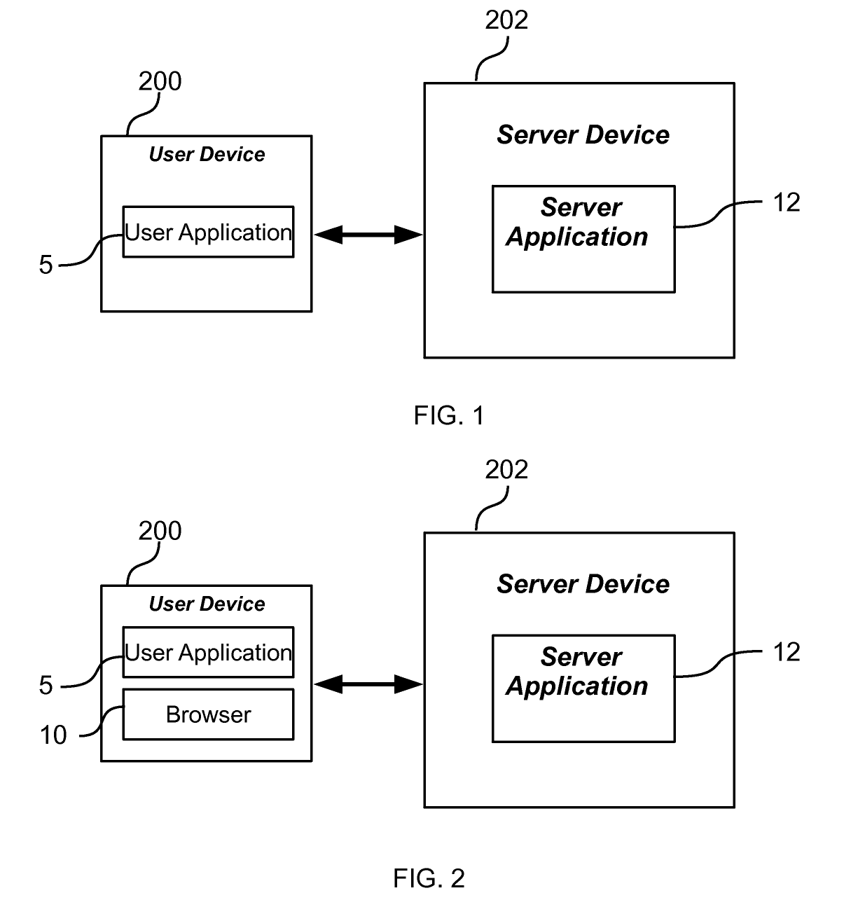

Referring now to the accompanying drawings and, in particular FIG. 1, which illustrates a block diagram outlining a belongings visualization and record system provided in a client-server network environment in which a user application 10 on a user device 200 communicates with a belongings visualization and record server application 12 operating on server device 202. Communication between user device 200 and server device 202 takes place across a computer network according to an embodiment. User application 10, in conjunction with belongings visualization and records server application 12, enable a user to organize belongings by location and associate them with related files. User application 10 and belongings visualization and records server application 12 may be practiced in many different environments. By way of example, user application 10 may be implemented using a web browser that connects to remotely-hosted websites and allows a user to navigate such websites across a network. Belongings visualization and record server application 12 may be implemented as at least one network server site, as a cloud service or by other techniques. For example, network service site functions may be provided by a cloud computing facility in which the services and functions attributed herein to the file share server are delivered as a service over the internet rather than by a specific server or cluster of servers. The computer network over which user application 10 and belongings visualization and record server application 12 function may be the Internet, but equally can be any one of, combination of, or interconnection of, but not restricted to: a local area network (LAN); a wide area network (WAN): a home network; and a wireless network.

In the client-server embodiment described above, the sequence of acts described above is implemented as an interactive Web page that is provided to web-enabled client device 200 for display through a Web browser. In one example, user application 10 is implemented via the web browser 11 (shown in FIG. 2) and responds to instructions, such as HTML5 instructions, from the computer network. A client-side scripting engine that executes programming language such as but not limited JAVASCRIPT® from Oracle Corporation of Redwood Shores, Calif., or the like. In one embodiment, the web browser is configured to use Ajax (asynchronous JavaScript and XML or JSON) web development techniques that are used to create interactive web applications.

In another embodiment, replacing the client-server paradigm, belongings visualization and record server application 12 is embodied in a downloadable, executable software application (known to those skilled in the art as an “app”). In such an embodiment, belongings visualization and record server application 12 operates directly on a client device and all modules and databases are stored locally on user device 200.

The software system is embodied in modules described above which are stored in system storage/memory. The software system can include an operating system having a kernel of commands and a shell or interface that encompasses the kernel and makes calls to the commands within the kernel. One or more application programs or modules may be loaded (i.e. transferred from storage into memory for execution by the processor). Note that the term “module” as used herein may refer to a collection of routines and data structures that perform a particular task or implements a particular abstract data type. Modules may be composed of two parts: 1) an interface that lists the constants, data types, variables, and routines that can be accessed by other modules or routines and 2) an implementation that is typically private, accessible only to that module, and includes source code that actually implements the routines in the module. The term “module” may also simply refer to an application, such as a computer program design, to assist in the performance of a specific task. In other examples, at least part of the modules may be implemented by hard-wired logic or other circuitry.

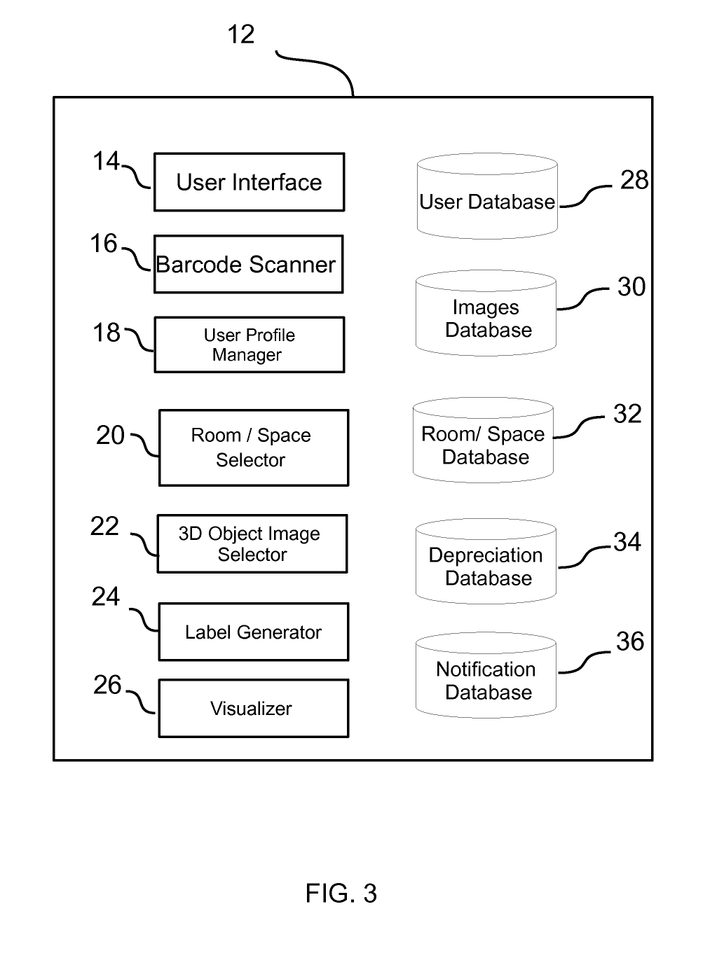

FIG. 3 illustrates the functional modules of belongings visualization and record server application 12. User interface 14 is a software module that operates to provide communication between user commands received from user application 10 executed on client device 100 and belongings visualization and record server application 12 executing on belongings visualization and record server 102.

Barcode scanner 16 is a software module that operates to scan, photograph, or otherwise capture a visual code associated with an item or a service. Examples of visual codes include traditional UPC bar codes, and more modern QR bar codes and three dimensional QR bar codes. Such visual codes can contain increasingly many data per code, and as the bar code grows in size and complexity, so does the amount of data contained within its appearance. Other visual codes may also be used, such as computer readable-characters and the like.

User profile manager 18 is a software module that operates to maintain user profiles compiled by belongings visualization and record server application 12 to organize data related to individual users. Such data is used to identify individual users, and correlate events such as birthdays, purchase histories, user preferences, address changes, and other data specific to individual users.

Room/space selector 20 is a software module that operates to present individual rooms or spaces in a virtual space selected by a user in which a user chooses to place representations of real-world items represented by images. For example, a user can construct a model of his or her residence, having a kitchen, a living room, bedrooms, bathrooms, a garage, an outdoor area, and the like, all represented by rendered images of such spaces in three-dimensional images that can be navigated by a user.

3D Object image selector 22 is a software module that operates to present a plurality of images a user, and allow the user to select a presented image and associate it with an item to be stored in the user's virtual space. Such objects can be stock images, or photographs, or computer-generated images of items.

Label generator 24 is a software module that operates to associate labels with the object image selected by a user using 3D object image selector 22. These labels can be placed on the object image, or associated with the object represented by the image and accessible through a pointing device such as a mouse or a touch pad.

3D Belongings visualizer 26 is a software module that operates to allow placement of the 3D object image selected by the user within a virtual space. It can be a drag and drop function, or a point and click function, or any other suitable method of manipulating an image to place it within another image.

User database 28 is a data store that stores and organizes user profile information and is maintained by user profile manager 18. Object images database 30 is a data store that stores and organizes images of items that are presented to a user and is maintained by 3D object image selector 22. Room/space database 32 is a data store that stores and organizes three-dimensional spaces in which a user places object images. Room/space database 32 is maintained by room/space selector 20. Optional depreciation database 34 may be included in embodiments to provide depreciation functions that depreciate items according to schedules selected by a user. For example, an automobile object stored in a virtual space representing a garage can be associated by the system with a value stored in depreciation database. Alternatively, the current value according to a depreciation schedule can be a field or file stored in association with the object in another database as an added field. A valuation function can be included that presents to the user the values of individual items as attributes of the item image as well as a value summation function that optional notification database 36 may be included in embodiments to store notifications in the form of messages related to items scanned by the user and stored in room/space that constitutes a user's virtual space. In such embodiments, belongings visualization and record server application 12 obtains notifications related to products based on polling a source of such updates, such as a manufacturer database, or monitors a user's email account for such messages that would normally be emailed to a user. By tying depreciation schedules to items, and communicating the depreciated value to a commercial website, an item that falls below a value threshold may indicate a user's readiness to replace an item, which is useful information to sellers of related items who may wish to provide incentives to replace an item by emailing an invitation to buy a replacement item at a discounted price. In an embodiment, delivery status of the notification to the user can be monitored; if a user fails to acknowledge the notification over time, the notification can be presented repeatedly or the belongings visualization and record server application 12 can cease to function until the user acknowledges the notification, either accepting it, responding to it, or dismissing it.

In one example, belongings visualization and record server application 12 is configured to determine if the depreciated value of the item has fallen below an associated value threshold. In response to determining the depreciated value of the item has fallen below the value threshold, the server application sends an electronic communication invitation, such as email, over the network to the user's account offering a replacement for the item. The server application may perform a search of commercial websites to match one or more potential replacement items with corresponding characteristics and properties of the item to be replaced and send this information to the user in an electronic communication. Alternatively or additionally, the server application may determine from the objects database the original vendor of the item that is to be replaced and send an electronic communication to the vendor over the network so as to alert the vendor.

In another embodiment, the object image database, or another database, contains parameters which can be used to determine if or when one or more items expire or are no longer compatible with the appropriate present technological standards, such as software or hardware standards or versions, or other requirements or regulations, such as building codes, electrical codes, automobile regulations, emission regulations (this will depend on the type of item). The server application is configured to perform a search of appropriate commercial, technological or government websites for such parameters associated with current replacement items and determine if the item to be replaced has expired or is no longer compatible with the appropriate hardware, software or other requirements. In response to determining the item has expired or is no longer compatible, the server application sends an electronic communication invitation, such as email, over the network to the user's account offering a replacement for the item. The server application may perform a search of commercial websites to match one or more potential replacement items on offer for purchase with corresponding characteristics and properties of the item to be replaced and send this information to the user in an electronic communication. Alternatively or additionally, the server application may determine from the objects database the original vendor of the item that is to be replaced and send an electronic communication to the vendor over the network so as to alert the vendor.

The embodiments described herein can provide nonconventional applications as well. For example, for a health care application, a user can create a medicine cabinet in a bathroom, or a cabinet in a kitchen, where prescription medications are stored, and scanned visual codes associated with the medications can be associated with medical records, or trigger searches for refills, or new safety warnings associated with the medications, or physician contact information, or schedule office visits with health care professionals. In another example, a student's school backpack can be represented from a scanned visual code, and school information, teacher contact information, academic information for individual classes, emergency contact information, allergy information, and any other digital assets that relate to the student, may be stored and associated with the backpack image in the virtual space.

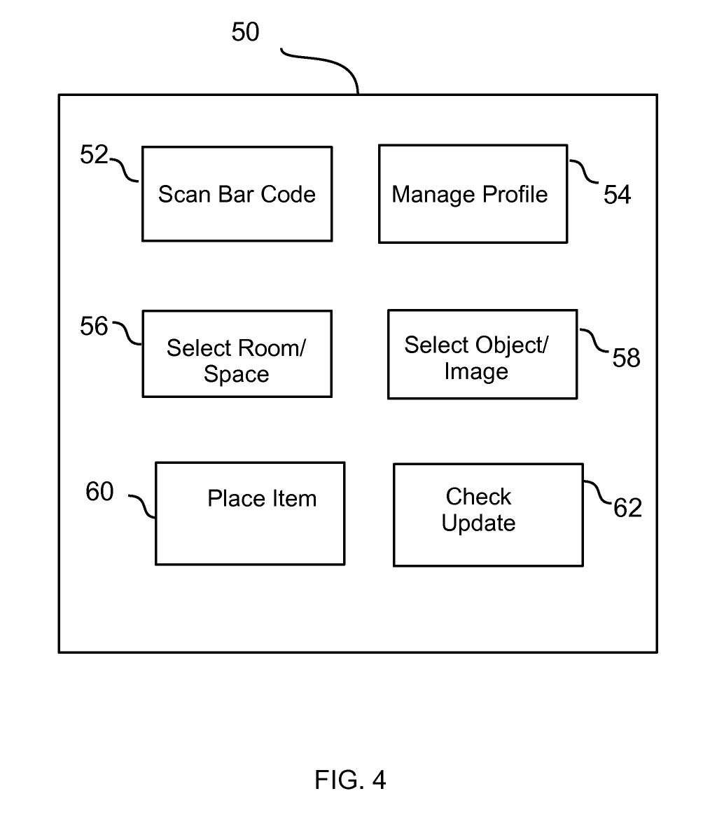

FIG. 4 illustrates one screen shot of an exemplary client-side user interface rendered on user device 200 that enables user application 10 to view and interact with belongings visualization and record server application 12 on server device 202 according to one embodiment. User interface 50 can be manipulated on user device 200 by the user to provide a variety of screen views in response to user selection that enable the user to scan visual codes, upload images, and manipulate functional modules on belongings visualization and record server application 12. In the non-limiting example shown in FIG. 4, the screen shot shows user interface 50 presenting a series of selectable functions to a user in a touch screen embodiment. Scan barcode module 52 operates a scanning function connected to user device 200. In an embodiment, this is a digital camera found on smart phones such as those produced by Apple, Inc. of Cupertino, Calif. Scan barcode module 52 is the client side equivalent of barcode scanner module 16 on the belongings visualization and record server application 12. Manage profile 54 allows a user to command user profile manager 18 on belongings visualization and record server application 12. Select room/space module 56 allows a user to operate room/space selector 20 on belongings visualization and record server application 12. Select 3D object image module 58 allows a user to operate 3D object image selector 22 on belongings visualization and record server application 12. Select label module 24 allows a user to operate label generator module 24 on belongings visualization and record server application 12. Place item module 60 allows a user to operate 3D belongings visualizer module 26 on belongings visualization and record server application 12. Check update module 62 allows a user to query notification database 36 for any messages received that relate to belongings associated with the user's virtual space.

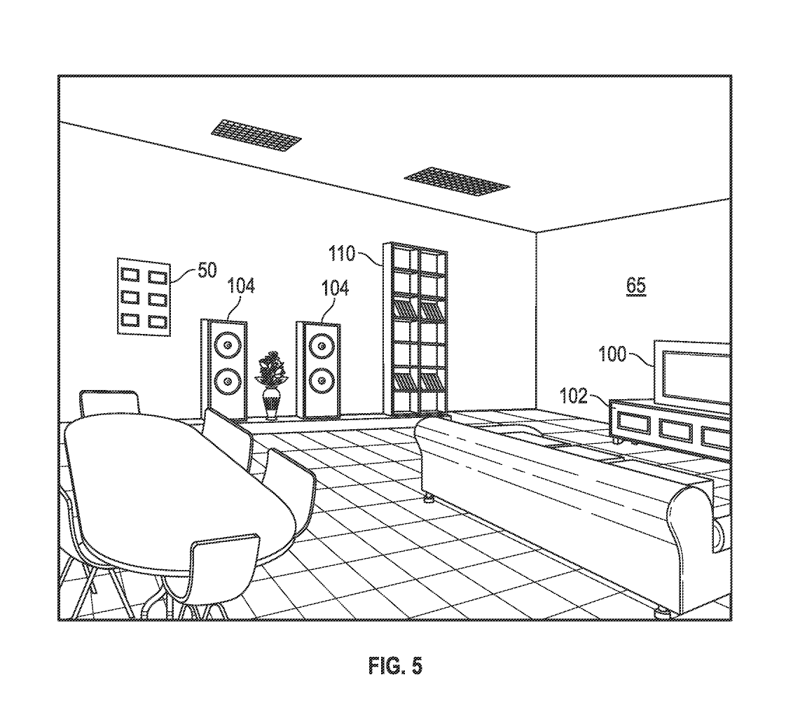

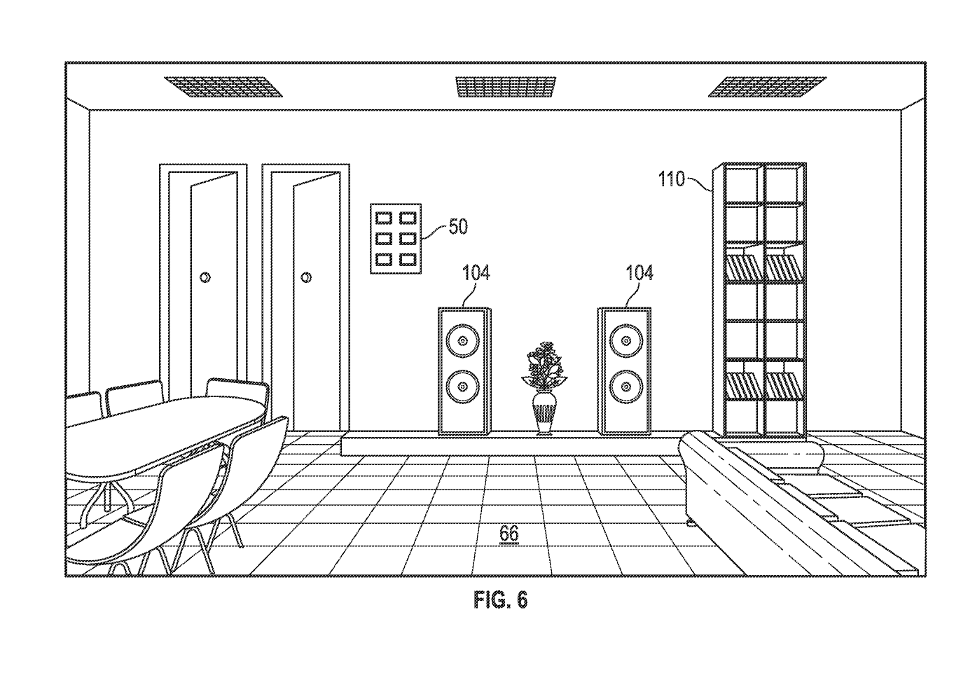

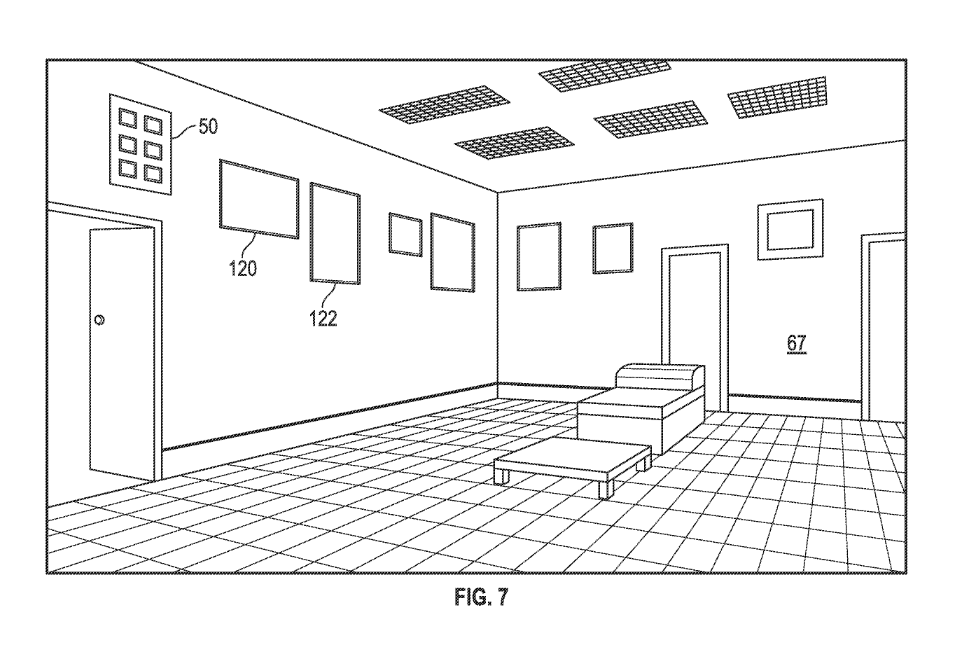

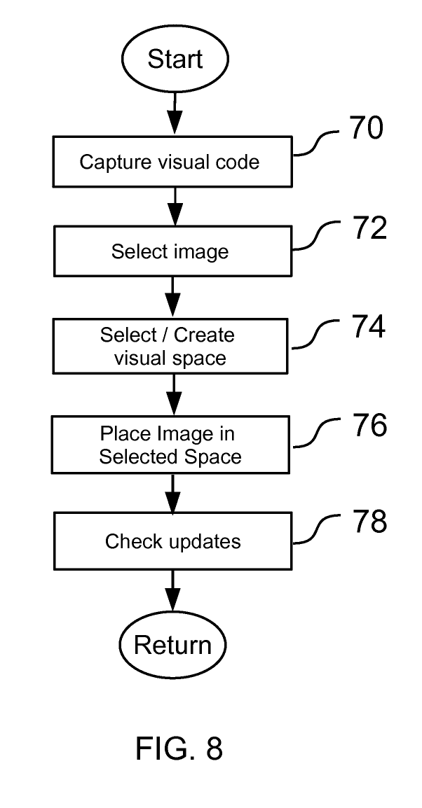

FIGS. 5-7 illustrate exemplary three dimensional room images 65, 66, 67, respectively, in which a user can place images of objects using place item module 60. By first selecting a room using room/space module 56, and retrieving room image 65, 66, or 67 from Room/Space database 32, the user can utilize three dimensional images of rooms or spaces, and change the view using conventional graphics operations of rotation, translation, and scale, to simulate movement within a space. For example, the view can show one wall of a room in one room, but then by manipulating view through a directional button on a keyboard, or manipulating a touch device such as a touch pad on a lap top computer or a touch screen on a mobile device, the display of the selected space will rotate, and an adjacent wall of the room will be displayed. This change in view can be seen as room images 65 and 66 (FIGS. 5 and 6) are different views of the same room, as if the user is standing in a different part of the room and looking in a different direction. Rooms can be linked together as they would appear in a real-world setting, so that a user can “pass through” rooms to find different spaces and place different objects in different rooms.

FIG. 8 illustrates in flow chart form a typical sequence of steps executed to capture a visual code and place an image in a user's virtual space. Directing attention to act 70, the user activates scan barcode module 52 and captures a visual code. This can occur in a store, where a user is in proximity to an item bearing a barcode, or by seeing the barcode in a print advertisement or on a webpage. Wherever a visual code is present and related to an item, the user can capture the code and introduce the associated item to his or her virtual space. At act 72, the user activates select image module 58, and at least one image is presented to the user for selection. In an alternative embodiment, a webpage associated with the item is presented, for example a manufacture website or a merchant website that displays images of the item. The user can then choose one or more images, for example a 3D representation or simply a 2D image, or even a video, that can be stored as an image file in object image database 30. Other files associated with the item can also be stored in object image database 30. For example, a user manual in digital form, or a warranty, or other product information can be retried and stored. A receipt for purchase, a depreciation schedule, links to information such as discussion groups or blogs related to the item can be stored, or contact links to merchants selling the item or servicing the item can be stored. Maintenance schedules can be stored, as can correspondence with service providers that repair or maintain the item. This is particularly useful for high-value items or durable goods, which a user may own for a long period of time and hope to recoup a large investment through extended use. In an embodiment, an advertisement for a related item may be received in this manner, such as a coupon for a discount on the purchase on the updated item or a related item. Once an image is selected, the user can then choose to associate files to it from object image database 30, or, at act 74, choose a virtual space in which to place the item by activating select room module 56. Typically, the user has already created a virtual environment, such as a configuration of rooms that represent a home, an office, a shop, or other space in which the user wishes to store virtual objects. This can be achieved through manipulation of the manage user profile module 54, in which a user can build the virtual space room by room and connect the rooms together. Once the room or space has been selected, at act 76 the user can place the image related to the item in the selected room or space. At act 78, the user can activate check updates module 62, and actively search for any product bulletins, safety warnings, service announcements, product upgrades, or correspond with a service provider to set a service appointment or troubleshoot a problem occurring with the item.

Returning to FIGS. 5-7, exemplary room images 65-67 may be presented to a user as selectable rooms as described above with respect to act 74. Room images such as 65-67 may be rendered by graphics applications that draw and shade portions of the images, and allow the user to place items within the room images as items scanned at act 70 and associated with images at act 72. For example, directing attention to FIG. 5, television 100 may be an item placed by the user. The user may have associated warranty information, updates, user manuals, and the like, in digital form, with an object or other data structure represented by television 100. Similarly, cabinet 102, on which television 100 rests, may contain unseen items, such as a stereo, that are associated with speakers 104, placed elsewhere in room images 65, 66. Bookshelf 110 can store a virtually unlimited amount of digital assets such as music, movies, images, photographs, and the like, as they can be shown on bookshelf 110 individually or as part of an indistinguishable plurality of assets, for example, a music collection. As described above, room images can be related or connected so that it appears that a user is moving from one room to another, for example from images 65, 66 of a room, to image 67 of a completely different room, such as an art gallery. Here, in image 67, there is shown a plurality of artwork displayed on walls of a virtual art gallery. In such an application, data structures represent individual pieces of artwork can be organized differently from consumer electronics, and can incorporate artist bios, descriptions of the art, artist contact information, pricing information, and the like. For example, art piece 120 may have a blog or social media connection to it, while art piece 122 simply has a sale price contained in its data structure. By presenting user interface 50 to a user as an overlay to room images 65-67, as desired by the user, the user is able to select functions to perform from user interface 50 in the virtual room as shown in FIGS. 5-7. In an embodiment, the user can drag user interface 50 over an item, such as speaker 104, to select speaker 104 for manipulation of its image and underlying data structure.

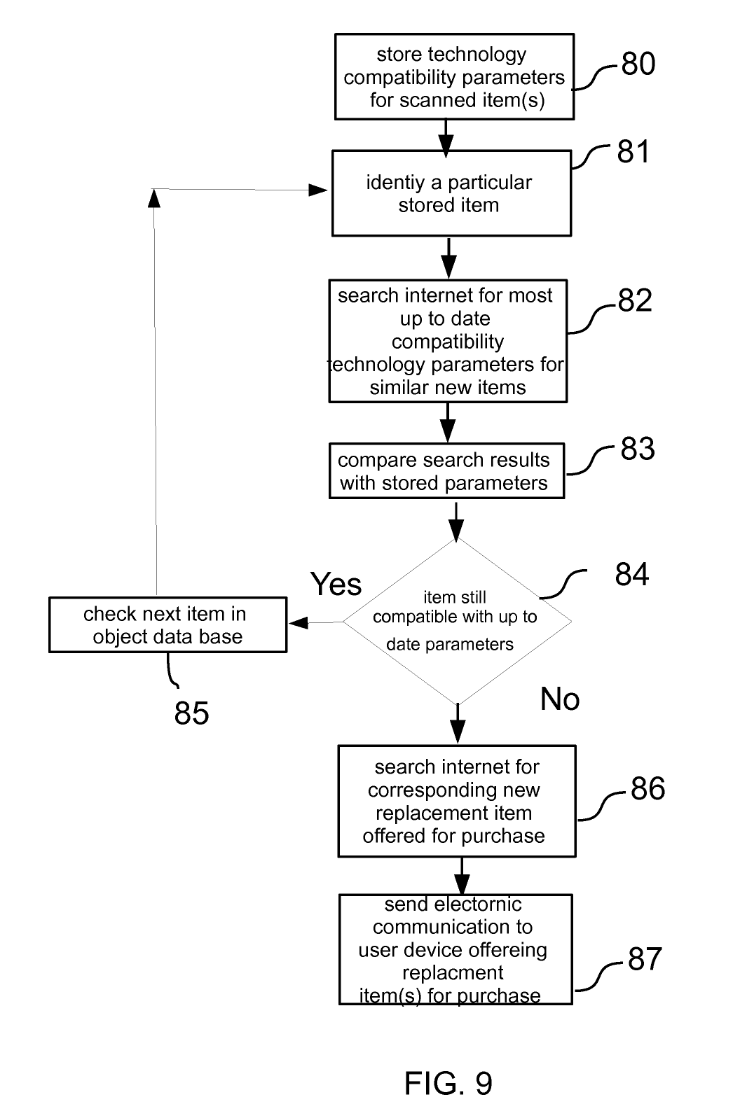

FIG. 9 illustrates in flow chart form a typical sequence of steps executed by the server to manage updating or replacement of an item according to one embodiment. Initially, the server stores files or other data containing technology compatibility/standard parameters for a scanned item in the object database (step 80). In response to receiving a user instruction or automatically, the server application looks up information on an identified scanned item from the object database (step 81) and searches the internet for most upto date compatibility/standards parameters for a similar replacement new item (step 82). The server application compares any retrieved compatibility/standards parameters for the similar replacement item with the compatibility/standards parameters of the item (step 83). Server application determines from the comparison whether the item is no longer compatible with current technological standards or other requirements or is at the end of it's typical operating life (step 84). In response to determining the item has expired or is no longer compatible, the server application searches over the internet for one or more updates or replacement new items offered for purchase (step 86) and sends an electronic communication invitation, such as email, over the network to the user's account offering a suitable update or replacement item for purchase(step 87). In response to determining the item has not expired or is still compatible with current technology standards, the server starts the process of checking compatible of another item in the object database (step 85).

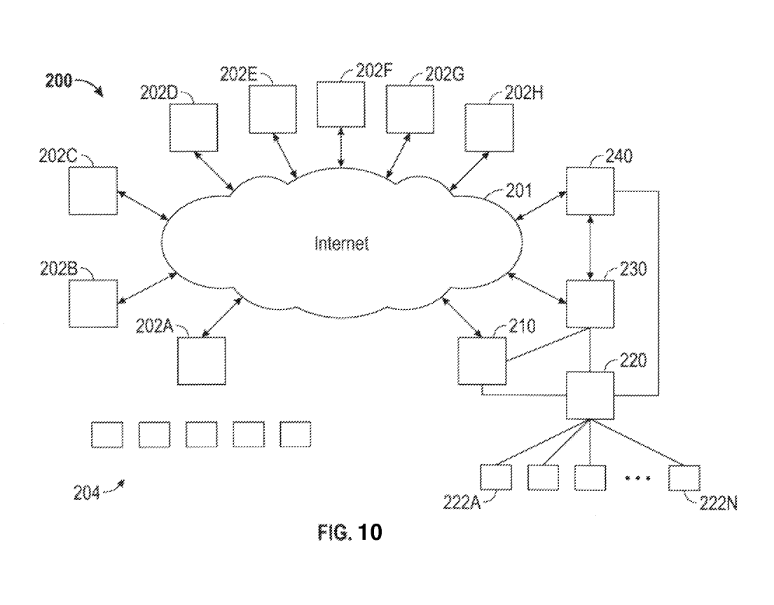

Directing attention to FIG. 10, a relational illustration in block diagram form of file server 200 and a plurality of user devices and equipment 202 are shown. File server 200 refers broadly to a configuration of equipment that as a system functions to collect files from users and to distribute files to users. In an embodiment, file server 200 may include multiple servers, each of which has functionality that is well-known by those skilled in the art. For example, file servers 210, 220,230 and 240 are servers operating as file server 200. Server 210 is a streaming media server. Server 220 is a database server, handing individual data storage systems 222. In an embodiment, file server 200 includes a relational database that stores files with file descriptors indicating specific events, geographical locations, and times (not shown). File server 230 is a web server that controls communication with devices and equipment 202 over Internet 201. File server 240 is an e-Commerce server, which handles financial transactions with customers for file server 200. User devices and equipment 202 are shown in various configurations in FIG. 10, and while lines are drawn between user devices 202, it is to be understood that there is no requirement of direct, physical links between file share server 200 and user devices 202. Typically, communication between file share server 200 and user devices 202 is implemented over a computer network utilizing a telecommunications network, such as a public telephone network 202A, in communication with portable devices 204, which are devices such as cell phones, smart phones, tablet computers, notebook computers, and the like. Thus, users can be located at geographically diverse locations, such as different cities, states, and countries around the world. Also as shown, user devices 202 can be a large number of devices, indicated by user device 202N. As shown, file share server 200 and user devices 202 are associated in a traditional client-server relationship. File share server 200 acts as a coordinator of files received from and distributed to user devices 202 that are operated by individual users who form an exclusive group that embodies a social network. Other user devices can be desktop, laptop, workstation or server configurations such as file server 200 and operated by other entities, such as operating at well-known commercial websites, or simply access points providing Internet connectivity to other user devices.

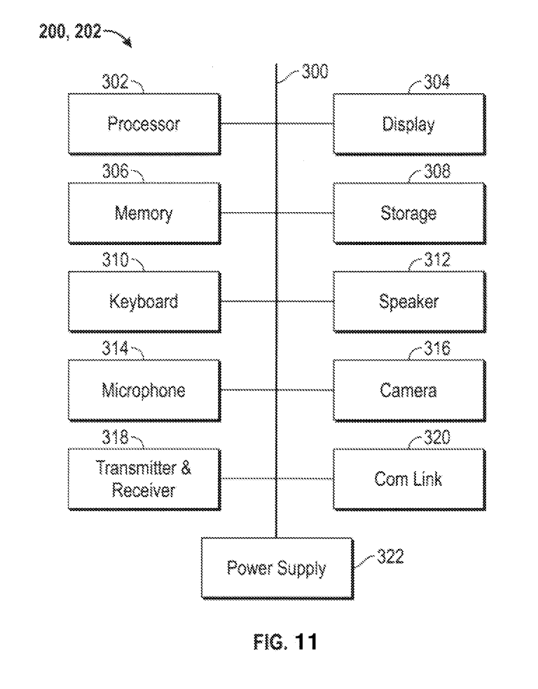

FIG. 11 illustrates in block diagram the major components of a computing device embodying file share server 200 and user devices 202. Bus 300 interconnects various functional components that combine to provide the functionality of a computing device. Processor 302 executes instructions loaded into memory 306 from storage 308. Display 304 is typically a screen upon which visual items are displayed to a user, such as text, video, photographs, and the like. Display 304 can also include a touch screen, and serve as an input device as well as a display. Memory 306 typically holds a file temporarily until it is either deleted, or stored in storage 308 or sent to another computing device. Keyboard 310 allows a user to type alphanumeric input to processor 302, but pointing devices such as a mouse or touch pad can also be utilized. Speaker 312 functions to provide an audio output to a user, such as music, ambient sound recorded at an event, audio overlays in which a human provides a spoken description of a file, and the like. Such audio can also be recorded by microphone 314 and placed in memory 306 and/or storage 308. Camera 316 may be included to capture video and photographs, which are placed in memory 306 or storage 308. Connection to a network, such as a computer network or telecommunications network can be via radio, utilizing transmitter and receiver module 318 and an associated antenna, or through a wired connection managed by communication link 320. Finally, power supply 322 can be either a battery, in the case of portable computing devices, or an alternating current supply such as used to power a stationary computing device such as a desktop computer or server farm.

While preferred embodiments of the present invention have been described and illustrated in detail, it is to be understood that many modifications can be made to the embodiments, and features can be interchanged between embodiments, without departing from the spirit of the invention.

What is claimed is:

1. A method of visualizing an item in an items management system, comprising:
a. receiving a digital representation of a machine-readable, visual code captured with a portable device, the visual code being associated with an item;
b. scanning the received visual code for an item identifier;
c. generating an item image from the item identifier, the item image consisting of a three-dimensional computer image representing the item;
d. placing the item image in a physical space image, the physical space image consisting of a three-dimensional computer image representing a physical space;
e. associating digital files with the item image;
f. associating the item image with a user profile; and
g. displaying the item image and the physical space image to a user on a computer screen.

2. The method of claim 1, wherein scanning the visual code comprises photographing the visual code with a digital camera.

3. The method of claim 1, wherein the physical space image in one of a plurality of associated physical space images comprises a plurality of different item images, wherein at least one image in the plurality of different item images bears a label.

4. The method of claim 1, wherein the visual code is associated with a manufacturer website.

5. The method of claim 1, wherein generating an item image comprises allowing a user to select an image from a collection of images.

6. The method of claim 1, wherein generating an item image comprises importing a photograph of the item from a remote source.

7. The method of claim 1, further comprising receiving a message related to the item and presenting the message to a user.

8. The method of claim 7, wherein the message comprises a service notification.

9. The method of claim 7, wherein the message comprises an invitation to buy a related item.

10. The method of claim 1, further comprising assigning a value to the item and reducing the value over a period of time.

11. The method of claim 1, wherein the digital files comprise a user manual.

12. The method of claim 1, wherein the digital files comprise a warranty.

13. The method of claim 1, wherein the digital files comprise a proof of purchase.

14. A computer system for visualizing items in a physical space, comprising:
a. a scanner module, the scanner module extracting information from a visual code;
b. a three-dimensional item visualizer module, the visualizer module generating three-dimensional item computer images corresponding to the visual code;
c. a physical space selector module, the space selector module generating three-dimensional computer images of physical space; and
d. an item image selector module, the item image selector module presenting a plurality of selectable item images to a user.

15. The computer system of claim 14, further comprising a label generator module, the label generator module operating to create a label for an item computer image.

16. The computer system of claim 14, further comprising a user profile manager, the user profile manager comprising a database of user profile information and a manager for retrieving, editing, and saving user profile information to the database.

17. The computer system of claim 16, wherein the computer system comprises a server application executing on a first computer in communication with a client application executing on a second computer.

18. The computer system of claim 16, wherein the computer system comprises a downloadable application software.

19. A method of visualizing and valuing items in an items management system, comprising:
a. receiving a definition of a virtual space and associating the definition with a user;
b. receiving a bar code associated with an item and obtaining at least one image of the item;
c. presenting the image to a user;
d. receiving placement instruction from a user and placing the image in the virtual space per the received placement instruction;
e. assigning a value to the item;
f. depreciating the value of the item according to a predetermined depreciation schedule;
g. summing values of all items represented by images in the virtual space; and
h presenting individual values of items in the virtual space and a total value of items in the virtual space to the user.

20. The method of claim 17, further comprising receiving an invitation to buy a related item.
